(19) United States
(12) Patent Application Publication
(10) Pub. No.: US 2011/0116757 A1
(43) Pub. Date: May 19, 2011

(54) OPTICAL FIBRE DISTRIBUTION MODULE WITH STORAGE REELS AND ORGANISER

(75) Inventors: Pieter Vanmeulen, Tielt Winge (BE); Pieter Arthur Anna De Vos, Berchem (BE); Barbara Maria Willems, Heverlee (BE)

(73) Assignee: Tyco Electronics Raychem BVBA, Kessel-Lo (BE)

(21) Appl. No.: 12/737,349

(22) PCT Filed: Jun. 30, 2009
(86) PCT No.: PCT/GB2009/050756

§ 371 Date: Jan. 3, 2011

(30) Foreign Application Priority Data
Jul. 4, 2008 (GB) 0812268.1

(51) Int. Cl. G02B 6/46

(52) U.S. Cl. 385/135

(57) ABSTRACT

An optical fibre distribution module (27) comprising at least one optical fibre organiser (100) for storing optical component (s) and/or fibre fed to/from the organiser, an array of optical fibre storage reels (29) attached to the said organiser and a plurality of optical connectors (24, 26), each reel storing a length of optical fibre having an end carried on the reel for optical connection with any selected one of the said connectors for making an optical connection with a respective optical circuit/component and/or fibre (s) on the said organiser.

The present invention relates generally to optical fibre distribution systems, and in particular (but not exclusively) to distribution systems and fibre management in the context of Fibre to The Home (FTT/H/P/X) hereinafter referred to as FTTH.

Fibre to the home (FTTH) concerns the installation of optical fibres in the subscriber loop of telecommunications networks either instead of or to replace twisted copper pairs. At the present time there are two leading technologies for providing high speed access to telecommunications networks from the home or business premises, namely DSL Broadband which utilises existing copper pairs and FTTH. FTTH is on average ten times faster than DSL Broadband and is inherently non-asymmetric in the sense that FTTH network connections operate at substantially the same speed in both directions. Emerging high speed services such as high definition IPTV and the like are driving the requirement for higher speed access and consequently FTTH is emerging as the preferred high speed access technology, particularly for new homes and business premises where there is no existing network infrastructure.

In a fibre optical network, fibres are typically routed from a central office of a service provider via distribution means by which the “trunk” bundle of fibres is successively split up and individual fibres routed to their ultimate destination, typically to subscriber premises and homes in the case of FTTH. Within the central office, therefore, there is a very large number of optical fibres to be organised, and this organisation is generally undertaken in distribution cabinets, distribution frames, boxes and other devices of a distribution system.

In an optical distribution frame (ODF) there are two main types of connection, that is a permanent or “splice” connection between the end of an optical fibre arriving at the frame in a trunk bundle (and sometimes also departing from the frame in such a trunk bundle) and less permanent connections, which need to be accessible for occasional adaptation of the connections within the system and known as “patching” connections. The devices for making either of these types of connections will be referred to generally as connections, and the specific type identified where appropriate as splices and patching connections.

Because of the large number of connections between individual optical fibres which must be made in a central office, and in other parts of the distribution system, space is at a premium and the density of connectors (that is the number of connectors which can be located within a given volume or, as is sometimes considered important, within a given “footprint” that is a certain area of floor space, must continually be reviewed and minimised.

There is a requirement, therefore, for a distribution system for optical fibres in which a high density of connectors is achievable, and which also has other advantages, in particular in facilitating the management of optical fibres and their connections by operators.

There is a requirement to provide an optical fibre distribution system which will economically achieve a high density, using components which are light and strong and sufficiently rugged to withstand the rigours of normal use, as well as protecting the optical fibres from excessive bending when connections are being made or changed.

According to an aspect of the present invention there is provided an optical fibre distribution module comprising a plurality of connectors or connector holders for making connections between optical fibres in which the connectors/holders are accessible from different directions on the module, the connectors/holders being arranged in an array adjacent a corresponding array of fibre storage openings for receiving respective fibre storage means each storing a length of fibre with a terminated end connector for connection to a respective one of the said connectors in a first direction, and an optical fibre organiser positioned on the module for connecting fibres fed to/from the organiser to the said connectors/holders in a second direction, the organiser being movable between an access position and a closed position to prevent access to the said connectors/holders in said second direction, whereby to provide demarcation between the accessibility of the connectors in the respective directions.

This aspect of the present invention achieves a particular advantage because the more permanent connections (that is those made say in the second direction, typically splices) require a skilled operator and, in the main, are made when the distribution module is being installed, or are pre-installed in the factory, whereas the connections made in the first direction, typically patching connections, can be changed by non-skilled operators or engineers when changes in circumstances require a different routing pattern through the distribution module or system of which the module forms part. By obstructing or inhibiting access to the connectors or connector holders in the second access direction and by making the connectors or connector holders readily accessible in the first direction, it is possible to locate the connectors or holders close to the organiser and thereby minimise the spacing occupied by them so that a greater density of connector units can be achieved. This arrangement provides for direct connections between splice and patch connections, preferably pre-fibred in the factory during manufacture of the module, which reduces the use of fibre and thereby module cost.

The organiser may be pivotally connected to the said module, preferably hinged to the module along a respective edge thereof. In preferred embodiments the organiser is hinged to the module housing along a bottom edge of thereof. This arrangement provides for ease of access to the contents of the organiser when the organiser is opened.

The organiser is preferably movable through an angle of approximately 90 degrees between its closed position and access position. In this way the organiser may be hinged downwards to adopt a flat horizontal orientation when opened.

The organiser is preferably positioned on an opposite side of the module to the said array of fibre storage openings. This also improves the aforementioned physical demarcation of the module for accessing different types of connections.

The hinge may define a route for feeding fibre from said organiser to the interior of the said module. This enables fibre to be feed along the hinge line so that effective fibre management can be achieved with only moderate twisting of the fibre along the length of the hinge will occur when the organiser is open and closed.

The module may be arranged for connecting fibres from a single optical fibre cable fed to/from the organiser with respective fibres connected to said connectors in said first direction, that is to say fibres from a single tube may be feed to the same organiser/module in a “single element” type arrangement for efficient fibre management and optimal fibre/connection density.

The module may have capacity for connecting between 8 and 24 fibres, preferably cables having 8, 12, 16 or 24 fibres.

The module may be is rotationally reversible in the sense that it is capable of being mounted in an array of modules in a first orientation and in another array of modules in a second orientation without change to its functionality.

Preferably the organiser is detachably mounted with respect to the said module to enable the organiser to be hinged to a respective bottom edge of the organiser independently of the orientation of the organiser. In this way if the module is mounted in one orientation and turned though 180 degrees in another the organiser can be re-positioned so that it occupies a preferred position, for example mounted along the bottom edge of the module.

The organiser preferably comprises a tray type structure with the open end closing against the module when in its respective closed position. For example, the organiser may have a generally rectangular shape corresponding in size to the open end of the module so that it covers the open end of the module when it is closed against the module.

The present invention also comprehends a telecommunications optical fibre distribution frame, box, cabinet or the like comprising at least one array of modules as described above.

The present invention also comprehends a telecommunications optical fibre distribution frame, box, cabinet or the like comprising at least one module according to the above mentioned aspect of the present invention on both a service provider side and a subscriber side of the frame, box, cabinet etc.

A telecommunications optical fibre distribution frame, box, cabinet or the like as previously described may comprise at least one module, according to the above mentioned aspect of the present invention, mounted on a hinge support so that the module may be pivoted between an open and closed position to provide access to both sides of the said module in use.

The present invention also comprehends a patching panel for a telecommunications optical fibre distribution frame, box, cabinet or the like comprising at least one module, according to the above mentioned aspect of the present invention, on both a service provider side of the said panel and a subscriber side of the said panel.

Various embodiment of the present invention will now be more particularly described, by way of example, with reference to the accompanying drawings in which:

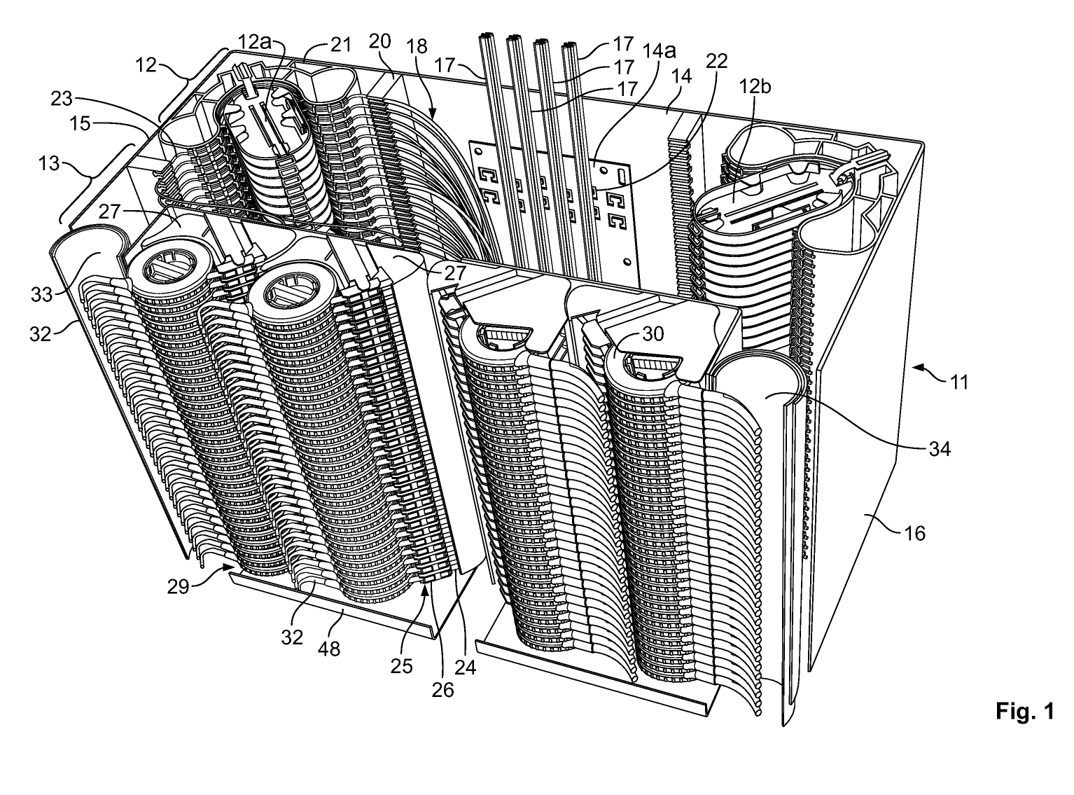

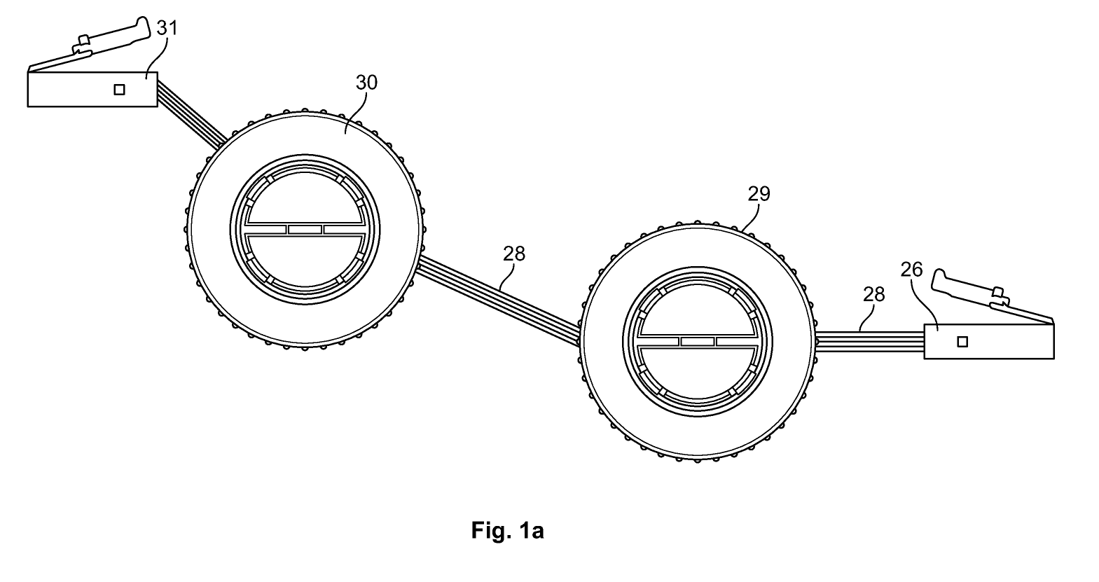

FIG. 1 is a perspective view of a modular unit for forming a distribution frame shown in its closed condition.

FIG. 1a is a schematic view of a jumper for making patching connections;

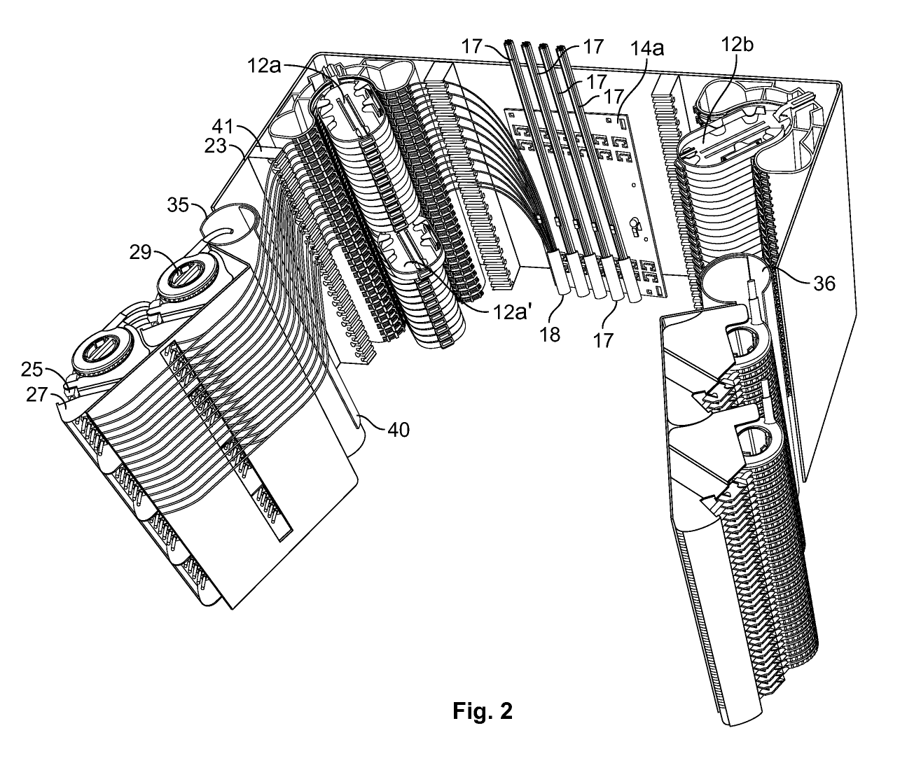

FIG. 2 is a perspective view from above illustrating the modular unit illustrated in FIG. 1 in an open or access condition;

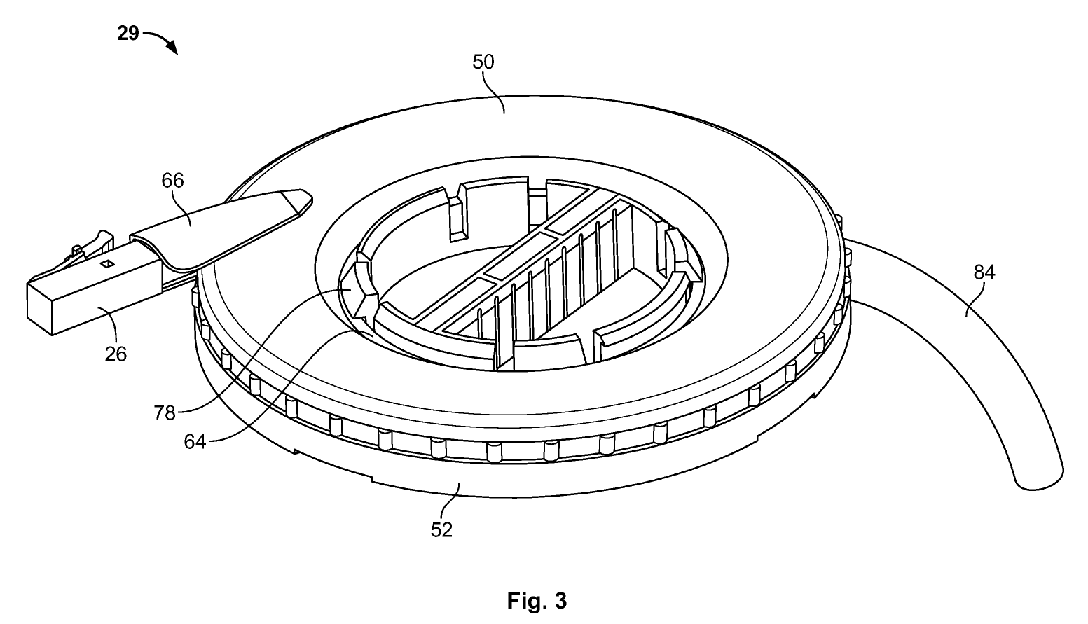

FIG. 3 is a perspective view of an optical fibre over-length storage reel connector for use in a fibre distribution module according to an embodiment of the present invention;

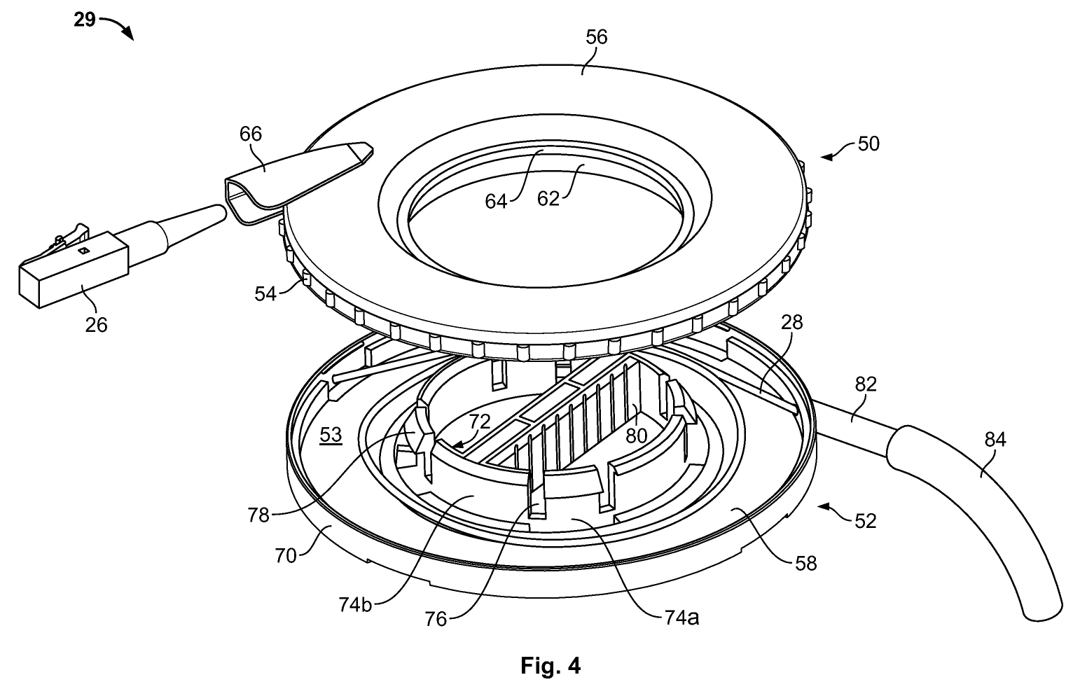

FIG. 4 is an exploded view of the fibre storage reel of FIG. 2;

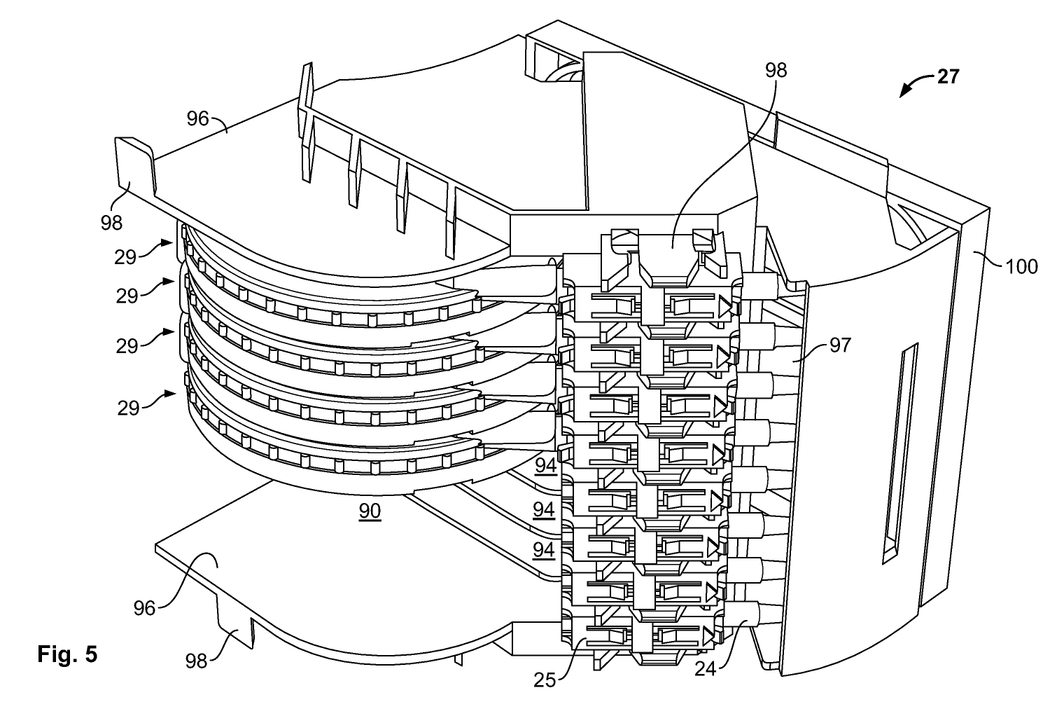

FIG. 5 is a perspective view of optical fibre distribution module according to an embodiment of the present invention with four over-length storage reel connectors installed;

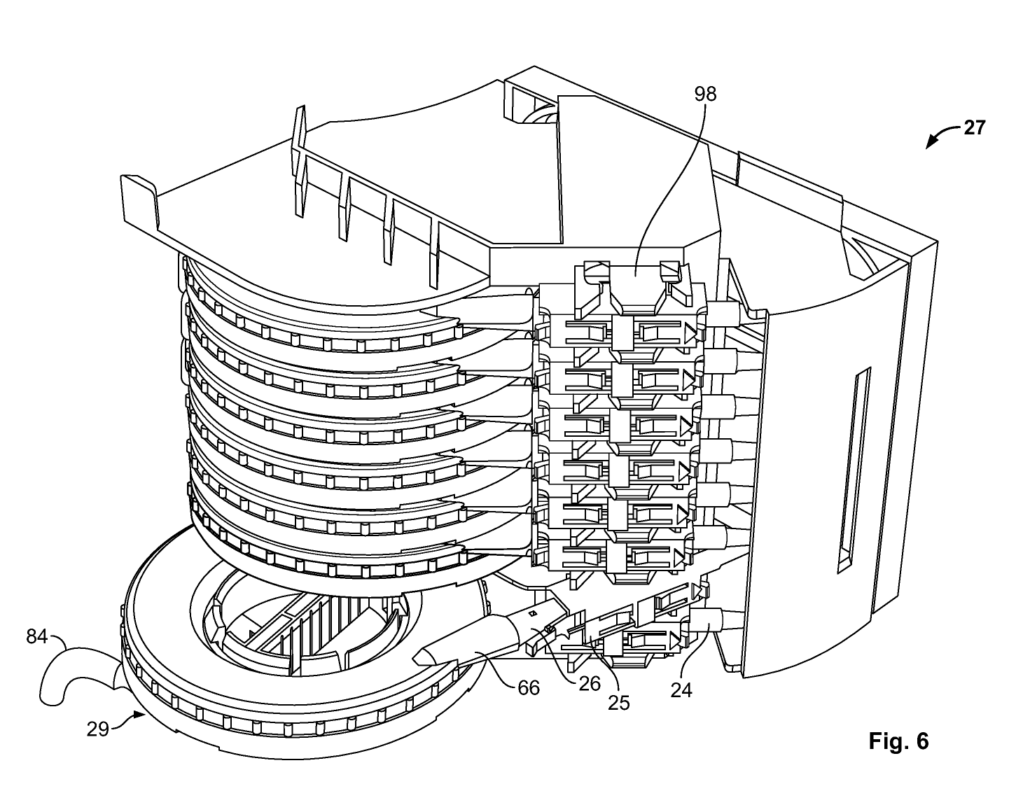

FIG. 6 is a perspective view similar to FIG. 5 with an over-length storage reel connector aligned with a corresponding connector on the distribution module and positioned for installation;

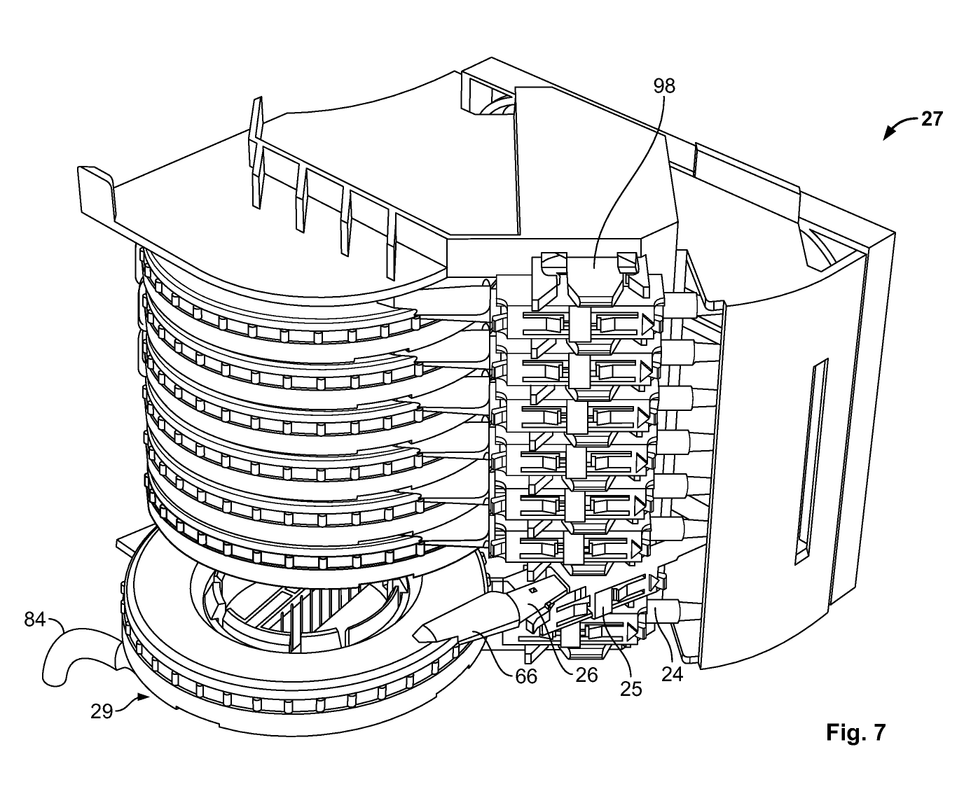

FIG. 7 is a perspective view similar to FIG. 6 with the overlength storage reel connected but prior to being moved to the retracted position of the other installed;

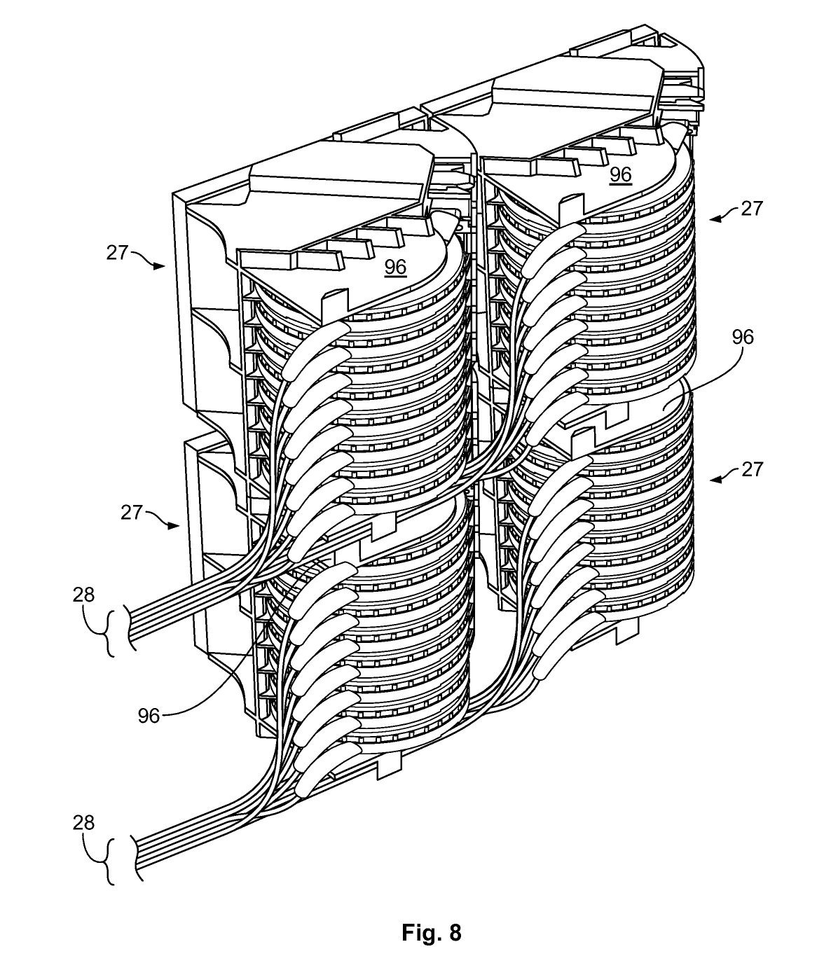

FIG. 8 is a perspective view of an array of optical fibre distribution modules of FIGS. 5-7 connected together to form a panel of distribution modules;

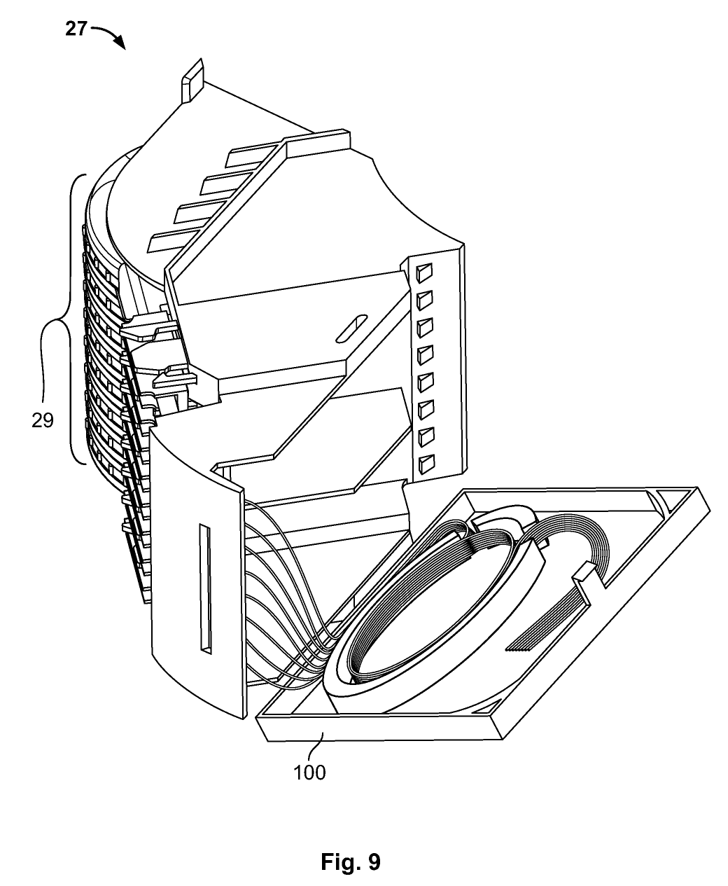

FIG. 9 is a perspective view from the rear of an optical fibre distribution module similar to that of FIGS. 5-8 having an integral splice tray, with the tray shown in an open position; and,

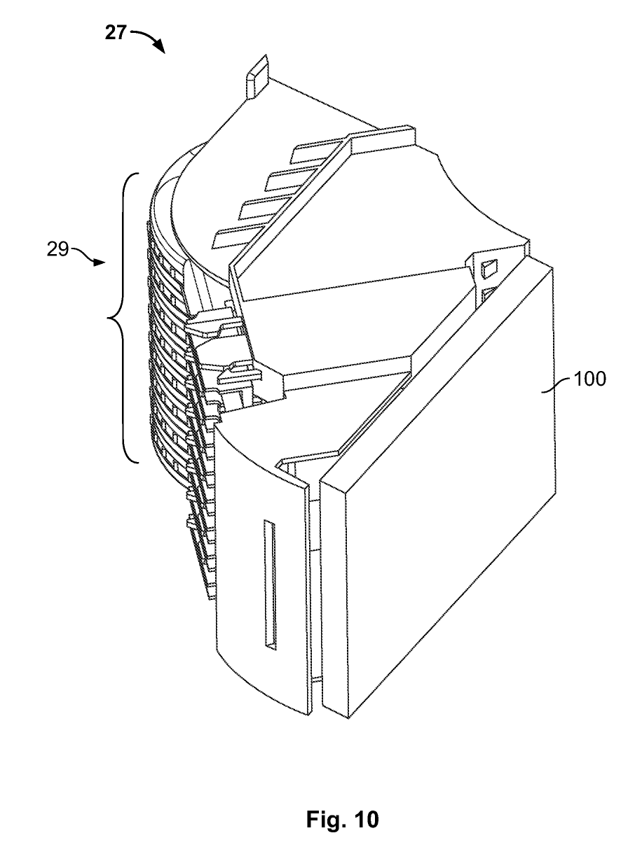

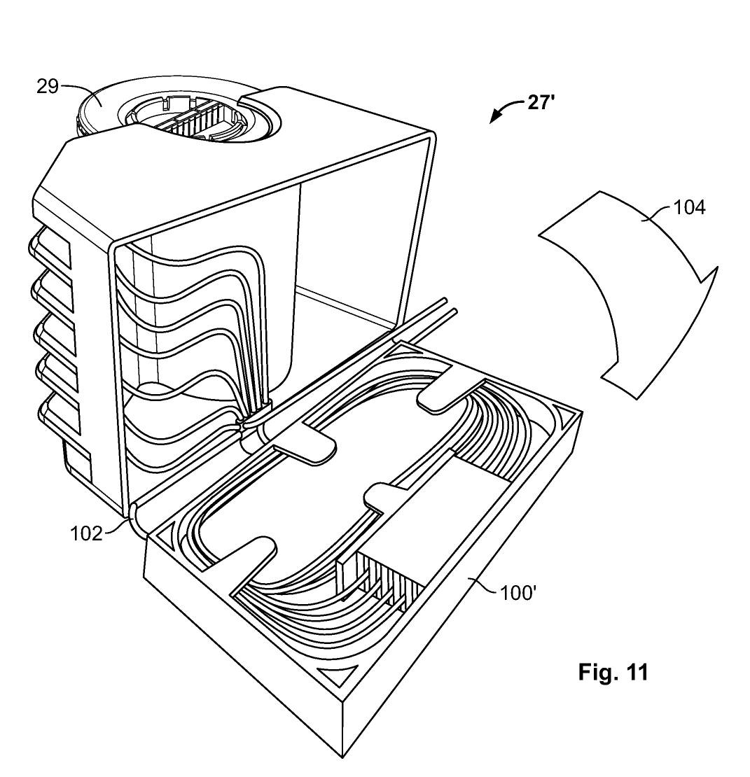

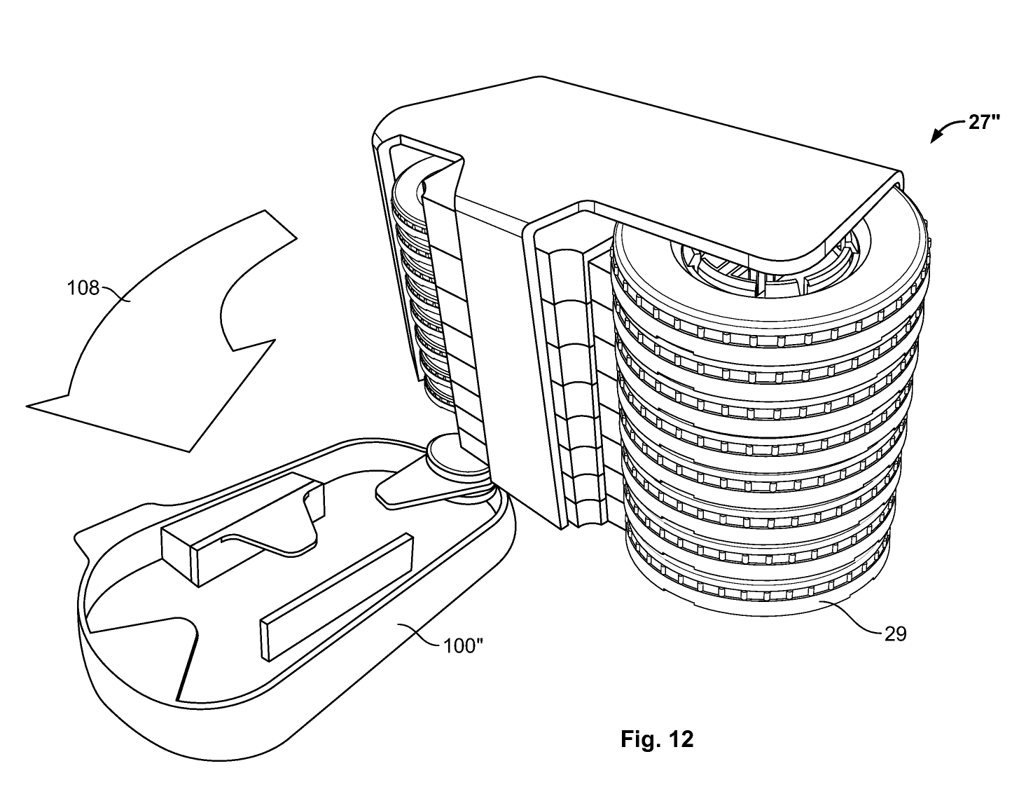

FIG. 10 is a perspective view of the optical fibre distribution module shown in FIG. 9 with the integral splice tray shown in a closed position.

Referring now to the drawings, there is shown a modular unit generally indicated 11 for forming an optical distribution frame suitable for installation in an optical fibre distribution network, particularly in a central office of a service provider.

As can be seen in the drawings and particularly FIG. 1, the modular unit 11 has two banks 12 and 13 of optical fibre connector units which will be described in more detail below.

The optical distribution frame modular unit 11 is shown in the drawings with a rear wall, 14 and left and right side walls 15, 16, but it must be emphasised that these boundary walls are illustrated for convenience of identifying locations and positions within the optical distribution frame and, in practice, may not be present, other support means being provided for the individual banks of connector units 12, 13 indeed the banks 12, 13 of connector units may be self-supporting as described below.

On the rear wall 14 of the modular unit 11 is an input cable support panel 14a which provides support and guidance for bundles of optical fibres in cables 17, 18 which may pass through the modular unit, as illustrated by the cables 17, or, as in the case of the cable 18, may be connected to the connector units within the optical fibre distribution module 11.

The bank 12 of the optical fibre connector units comprises two arrays of 12a, 12b (in this case, vertical stacks) of splicing connector units in the form of splice trays. Individual fibres 19 from the bundle 18 are lead out via a fixed guide or locator 20 from which each fibre is individually guided by a resilient guide arm 21 into a splice tray of the array 12a.

The splice trays in the array 12a are stacked vertically and each provided with guides (not shown), which inter-connect with one another so that the individual trays in the stack are each guided by their neighbours above and below them. The guide arms 21 are flexible and resilient and each allows the respective tray in the stack 12a to be drawn out along a rectilinear path whilst supporting and guiding the optical fibre or fibres carried on it so that each fibre does not exceed its minimum bend radius.

Suitable splice connectors (not shown in detail) are mounted on each of the splice trays of the arrays 12a, 12b for forming permanent splice connections between the fibres 21 leading from the bundle 18 and fibres 23 within the optical distribution frame 11 leading from the splice trays 12 to the bank of patching connectors 13. These fibres 23 are held in a flexible laminar array by a flexible laminar support (not shown). Each individual fibre 23 is terminated by a respective plug connector 24.

The plug connector 24 is engaged in one end of a selected double-ended socket 25 pivotally mounted to a rack of fibre distribution modules 27. The other end of the socket 25 receives a plug 26 connected to one end of an optical fibre 28 coiled in a wind-up coil unit 29. As is shown in FIG. 1a, the optical fibre 28 is a so-called “jumper”, namely an optical fibre length with a plug 26, 31 at each end for making patching connections. The plugs 26, 31 are carried on the casings of over-length wind-up coil units 29, 30 into which surplus fibres can be coiled as will be more fully explained with reference to FIGS. 3 and 4 below. Patching between two parts of the patch panel defined by the bank 13 of patch connector units on the left and right hand side of the modular unit 11, therefore, can be achieved by a plug-in connection of the two plugs 24, 26 with respective sockets 25, for which purpose the sockets 25 can be pivoted to an access position (shown in FIG. 7). The coil casing can then be pivoted into position into a holder of the rack 27. The optical fibre 28 leads out from the coil unit 29 via a curved guide 32 from which it can be routed, for example downwards through a guide duct 33 having a hinge function as will be described in more detail below, to a lower level in the optical distribution frame modular unit along a guide 48 from which it can be brought back up, for example along a guide duct 34 to the wind up coil 30, the plug 31 of which may be connected to a selected socket in this array 13 on the other side, right hand side, of the unit 11.

The ducts 33, 34, which are in the form of part-cylindrical tubular elements, are nested within corresponding similar part-cylindrical support guides 35, 36 to form a vertical-axis pivot hinge which also serves as a guide duct for the optical fibres of the patch panel constituted by the bank 13 of connector units and a hinge support structure for the distribution modules 27. Because the optical fibres have a relatively long drop between one end and the other there is sufficient freedom of movement to allow the two arrays of patching connectors to be pivoted about the hinges defined by the part-cylindrical guides 33, 35 and 34, 36 to the position illustrated in FIG. 2 to allow the user access to the splice trays 12a, 12b should it be desired to make a change to the splicing connections at a later date.

As can be seen in FIG. 2, when the two banks of patching connector units 13 are swung out about the pivot hinges defined by the part-cylindrical guides 33, 34, there is free access for an operator to reach the splice trays in the bank 12 to make splicing connections. It should be noted that the fibres 23 may be preliminarily fitted in the frame to provide a one-to-one relation between the splice trays 12 and the patching connector sockets 25. Then, when the splicing is complete the banks 13 of patching connectors can be swung to the closed position illustrated in FIG. 1, obstructing further access to the splice trays, but presenting the patch panel frontally to an operator for easy access to make whatever patching connections are desired.

Referring now to the drawings of FIGS. 3 and 4, which show a wind-up coil device 29 according to an embodiment of the present invention. The wind-up coil 29 constitutes an optical fibre storage reel comprising a pair of relatively rotatable toroidal members 50, 52. The toroidal members constitute respective axial halves of the device, which when in the assembled configuration of FIG. 3 define an enclosed toroidal region 53 for storing coils of optical fibre 28 with minimum bend control. The internal fibre storage region 53 extends between respective axial end walls 56 and 58 of the members 50, 52. The end walls are sufficiently spaced apart in the assembled device to accommodate a number of coils of fibre, for example 20-50 turns. The first of the toroidal parts 50 has an axially extending annular outer periphery 54 having a plurality of gripping elements 60 circumferentially spaced around the periphery. The inner circumferential periphery of the toroidal part 50 is provided by an axially extending annular wall member 62, which includes an inwardly projecting annular flange element 64 which constitutes one part of a reversible snap-fit connection for attaching the toroidal parts 50, 52 together. An optical fibre connector holder 66 is provided at one position on the outer circumference of the toroidal part 50 for receiving an optical fibre terminal connector 24 connected to the end of the fibre coiled within the device. The connector holder 66 extends beyond the outer circumference of the toroidal part 50 and as such provides a convenient means for winding fibre on the device by hand.

The axial end wall 58 of the second toroidal part extends between an outer axially extending annular wall element 70 and an inner hub 72 which comprises the second part of the snap fit connection for joining the two parts together. The hub comprises a plurality of circumferentially spaced arcuate wall segments 74a, 74b, which are separated by respective slots 76 at various locations around the hub's circumference. Each of the projections extend axially towards the other part 50 with four of the projections 74a being provided with hook engagement means 78 at their respective distal ends for reversible snap fit engagement with the radially extending annular element 64 on toroidal part 50. The engagement hooks are equally spaced around the periphery of the hub and are provided on narrower tab like resilient projections 74a between respective wider and therefore less resilient projections 74b. A diametrically extending gripping member 80 is provided between two of the wider projections to provide a convenient means by which the toroidal part 52 may be gripped between an operator's fingers in use.

A fibre entry/exit port is provided in the outer annular wall 70 with a guide element 82 provided on the external side of the wall for guiding fibre to and from the internal region 53 together with fibre guide 84, which may be in the form of a resilient elastomeric sleeve, attached to the entry/exit port 82. The guide 84 provides a suitable fibre bend control guide for the fibre entering/exiting the internal region of the device.

In one preferred embodiment it is envisaged that the wind-up coil device of FIGS. 3 and 4 will accommodate sufficient length of fibre for forming suitable fibre connections such as in the distribution module 11 previously described. For example, preferred embodiments envisage between 3 and 12 metres of fibre, having an external diameter (with jacket) of about 1.8 mm, being stored on a single device.

As previously described with reference to FIG. 1a, a wind-up coil 29, 30 may be provided at both ends of a length of optical fibre 28 to provide a “jumper cable” for patching connections. The present invention also contemplates embodiments where a plurality of wind-up coil devices 29 and associated fibres are part of a break out cable, that is to say where the individual fibres of a cable are each connected to a respective coil wind-up device 29 at these respective ends. Similarly the fibres at each end of an optical fibre cable may be connected to respective wind-up devices, for example in the case of an inter-facility cable. Other embodiments are also contemplated including over length “pigtails” for connection to other optical components devices and/or fibre(s).

As will be understood from the foregoing description, and in particular with reference to FIGS. 3 and 4, a length of fibre 28 may be wound onto or unwound from the wind-up coil device 29 by relative rotation of the respective toroidal parts 50, 52. For example in the drawings of FIGS. 3 and 4 rotation of the first part 50 in an anti-clockwise direction, with respect to the second part 52, will cause additional fibre to be wound onto the device, whereas excess fibre may be unwound by pulling the fibre while holding toroidal part 52 stationary, by gripping the gripping bar 80, so that the toroidal part 50 is caused to rotate in a clockwise direction as excess fibre is played out.

In the embodiment of FIGS. 3 and 4 the wind-up coil device has an axial depth of about 10 mm or so and a external diameter of about 60 mm or so and therefore is suitable for manual hand-held manipulation allowing the operator to reel out excess fibre stored on the reel by gripping the bar 80 and pulling the cable with sufficient force so that the other part 50 rotates, and likewise rotating the part 50 by engagement of the connector holder 66 on the external surface thereof to rotate the part 50 in the opposite direction to reel in excess fibre. It is to be understood that the fibre connector 26 may be of any suitable type with a holder 66 adapted to accommodate different types of connector as required. In preferred embodiments at least part of at least one of the parts 50, 52 is transparent or provided with a window so that the amount of fibre stored within the device can be observed. In addition, to prevent overstressing of the fibre and/or device in final part of the fibre near the connector 26 may be provided with a rigid reinforcement element such as an elongate metal bar which acts as a stop to prevent axial pull forces being transferred to the connector 24 as the fibre is unwound. As the final length of fibre is unwound the rigid member will not pass through the curved guide 84 and will therefore only allow a pre-determined length of fibre to be played out from the reel.

Typically the internal diameter of the reel, as determined by the annular wall element 62, may be 40 mm or even 30 mm or less with bend insensitive fibre, and typically the outer diameter may be 70 mm of more but of course the inner and outer diameter dimensions will be determined by the particular application.

Referring now to FIGS. 5, 6 and 7, which show a plurality of optical fibre wind-up coil devices 29 mounted in a fibre distribution modules 27. The fibre distribution module comprises an integrally moulded, preferably plastics moulded, component which constitutes a support and housing structure for receiving a plurality of wind-up coil devices 29 and associated connectors for connecting fibres carried by the respective wind-up coil devices with fibres entering the module 27 from another access direction, for example splice fibres 23 from the respective splice trays 12 as shown in FIGS. 1 and 2. As previously mentioned it is preferred, but not essential, to provide a one-to-one relationship between the respective splice trays and the wind-up coil devices. The module 27 readily enables this to be achieved since it comprises on one side an open region 90 for receiving a plurality of wind-up coil devices 29. The region 90 is divided in part by an array of parallel laminar wall members 92 which define an array of openings 94 which constitute holders for the respective wind-up coils when mounted within the module 27.

As shown in the drawing FIG. 5, the module 27 is illustrated with four wind-up coil devices 29 positioned in the four uppermost holders, with the four lower holders empty. In the preferred orientation of the module 27 the wind-up coil device holders are arranged in a vertical stack so that the wind-up coil devices stack one on top of the other as shown in the drawings of FIGS. 5 to 7, the weight of the respective wind-up coil devices 29 is therefore supported in the main by the respective walls 92, although it is to be understood that in other embodiments the walls 92 may constitute guide means for positioning the devices 29, with the weight of the devices being supported, in the main, by others means, such as the plug in-plug out sockets 25 and possibly one of the planar elements 96 which project forward of the openings 94 and define the upper and lower boundaries of the fibre storage region 90. In this respect the wind-up coil devices 29 may be constructed so that they are arranged to contact each other in the assembled stack so that the weight of the coils is supported to some extent by the stack and ultimately by one of the elements 96. A corresponding array or stack of connector holders 98 is provided adjacent to the openings 94 to receive a corresponding plug-in/plug-out socket 25. The plug-in/plug-out sockets 25 constitute adapters for connecting the respective connectors 24 and 26 at the ends of the respective fibres 23 and 28 as previously described. The connector holders 98 are aligned with the corresponding adjacent wind-up coil device holders so that the wind-up coil devices may be readily mounted within the module and connected to a respective adapter socket 25.

As can best be seen in the drawing FIG. 6 the adapter sockets 25 are each pivotally mounted within the holders 98 so that they may be pivoted outwards by a few degrees to provide access to the socket for connection to the fibre connector 26 carried by the wind-up coil device. In FIG. 6 wind-up coil devices are mounted in the six upper openings with a seventh device positioned for connection in the next available opening, with the connector 26 of the seventh device aligned with the opening of a respective plug-in/plug-out adapter socket 25. The drawing of FIG. 7 is similar to the view shown in FIG. 6 but with the fibre end connector 26 of the additional wind-up coil device being fully inserted in the socket 25 but before the wind-up coil device and socket are pivoted from the access position shown to the closed or stored position as occupied by the other wind-up devices in the stack.

In the drawing of FIG. 7 of the connector 26 is fully inserted in the socket adapter 25 and the wind-up coil device is positioned for rotation about the pivot axis of the socket 25 for movement into its respective opening 94 where it will be locked in position with the other wind-up coil devices in the stack mounted in the module 27. In preferred embodiments two sets of coaxial upstanding cylindrical projections are provided on the body of the socket 25 with one set defining the pivot axis of the socket and being engaged by corresponding snap fit engagement means provided on the holders, with the other set being spaced apart from the first set to provide a reversible snap-fit locking function with a second corresponding set of snap fit engagement means provided on the holders, spaced from the first.

In the illustrated embodiment of FIGS. 5, 6 and 7 the fibres 23 are fed into the rear of the module from where they pass through an opening 97 and connect to the other side of the plug-in/plug-out socket as previously described. The module preferably comprises space for eight or twelve wind-up coil devices and associated connectors, but of course embodiments are contemplated with other fibre connection capacities. The fibre distribution module 27 is provided with various connection means for connecting the module to adjacent modules or support structure in a distribution system, for example as shown in FIG. 1 where each side of the front of the distribution system includes two stacks of four fibre distribution modules 27 to provide sixty four connections on each side, both left and right hand side. The fibre distribution module of the present invention if preferably provided with connection means for interlocking engagement with adjacent modules, either above, below or to the left or right hand side so that a self supporting structure comprising an array of modules 27 may be provided, as shown in the orientation on the left hand side of the distribution system in FIG. 1 or in a second, inverted, orientation shown on the right hand side of the drawing in FIG. 1. The connection means are preferably in the form of reversible snap fit connections, (not shown) which enable an array of modules 27 to be joined together, with the modules adjacent a support structure, such as the hinge 32 in the drawing of FIG. 1, being connected to and supported by that structure, if necessary.

The forward projecting elements 96 also provide a means for guiding fibre 28 from the wind-up coil devices mounted in a module or array of modules. This can best be understood from the drawing of FIG. 8 where it can be seen that fibres from one module are grouped together and cascaded down to the region below a stack of wind-up connectors in an adjacent module so that they can be fed out at the same level, first passing through a fibre guide defined by adjacent elements 96 of neighbouring modules 27 in a stack of modules. Each of the elements 96 is provided with an orthogonal projection 98 in the form of a tab for holding the fibres in the region of the guide between the respective modules, again this can best be seen in the two-dimensional array of assembled modules shown in FIG. 8.

The fibre distribution module 27 may be further provided with a rectangular closure member 100, which closes the other side of the module, that is to say the side having the incoming fibres 23.

Referring now to FIGS. 9 and 10, in a preferred embodiment of the present invention the closure member 100 is in the form of a fibre organiser tray for organising fibres 23 on the other side of the module 27. The organiser tray 100 is preferably hinged to the bottom edge of the module but is preferably removable so that in other orientations it can be hinged to the opposite edge, for example when the module is rotated through180° and inverted, as previously described. The organiser tray could also be hinged to either the right or left hand side of the module, but the bottom/top edge arrangement is preferred so that the operator is presented with a flat horizontal surface when the tray/closure member is opened for access. In this embodiment it is possible for fibres from an incoming cable or loose tube to be spliced in the tray, with the splices and excess fibre and/or other optical components being stored in the splice tray. This embodiment is particularly suitable for so called “single element” connections where all fibres from a so called “lose tube” are arranged to be fed to a single module 27 where they are spliced or connected to other fibres or optical components in the splice tray 100 before connecting fibres are fed through the module for connection of the respective fibre end connectors 24 to the socket adapters 25. In preferred embodiments means (not shown) are provided for locking the splice tray 100 to the module 27 when in the closed position as shown in FIG. 10 to prevent unauthorised access to the splice tray and thereby control the demarcation of operator activities, particularly between splicing and patching connections. The capacity of the module and splice tray is preferably matched so that in applications where a lose tube is to be connected having say 8 individual fibres the splice tray and module will be configured to have capacity for connecting that number of fibres. Embodiments are envisaged having any number of fibres but embodiments having capacity for 8, 12, 16 or 24 fibre connections are preferred.

1. An optical fibre distribution module comprising at least one optical fibre organiser for storing optical component(s) and/or fibre fed to/from the organiser, an array of optical fibre storage reels attached to the said organiser and a plurality of optical connectors, each reel storing a length of optical fibre having an end carried on the reel for optical connection with any selected one of the said connectors for making an optical connection with a respective optical circuit/component and/or fibre(s) on the said organiser.

2. An optical fibre distribution module as claimed in claim 1 wherein the said organiser is movable with respect to said array between an access position and a closed position to prevent access to the contents of the said organiser when in the closed position.

3. An optical fibre distribution module as claimed in claim 1 wherein the array of storage reels comprises a stack of the said reels.

4. An optical fibre distribution module as claimed in claim 4 wherein the said organiser, in its closed position, lies substantially within the footprint of the said stack, or closely along the perimeter thereof.

5. An optical fibre distribution module as claimed in claim 1 wherein the said connectors comprise a first set of patch connectors and said fibre storage reels connect said first set of patch connectors to selected connectors in a second set of patch connectors, on said module or remote therefrom.

6. An optical fibre distribution module as claimed in claim 1 wherein the said organiser is pivotally connected to the said array of fibre storage reels.

7. An optical fibre distribution module as claimed in claim 6, wherein said organiser is movable through an angle of approximately 90 degrees between a closed position and access position.

8. An optical fibre distribution module as claimed in claim 1 wherein the said organiser is positioned on an opposite side of the module to the said array of fibre storage reels.

9. An optical fibre distribution module as claimed in claim 1 wherein the said module is arranged for connecting fibres from a single optical fibre cable fed to the said organiser with respective fibre storage reels.

10. An optical fibre distribution module as claimed in claim 9 wherein said module is adapted for connecting between 8 and 24 fibres, preferably between 8 and 12 fibres from a single cable, preferably cables having 8, 12, 16 or 24 fibres.

11. An optical fibre distribution module as claimed in claim 1 wherein the said module is rotationally reversible so that it is capable of being mounted in an array of modules in a first orientation and in another array of modules in a second orientation.

12. An optical fibre distribution module as claimed in claim 11 wherein the said organiser is detachably mounted with respect to the said module to enable the organiser to be hinged to a respective bottom edge of the module independently of the orientation of the organiser.

13. An optical fibre distribution module as claimed in claim 1 wherein the said organiser comprises a tray type structure with the open end closing against an open end of the module when moved to its respective closed position.

14. An optical fibre distribution module as claimed in claim 13 wherein the said organiser has a generally rectangular shape corresponding in size to the open end of the module which is covered by the said organiser in its closed position.

15. A telecommunications optical fibre distribution frame, box, cabinet or the like comprising at least one array of modules as claimed in claim 1.
